(19) United States
(12) Patent Application Publication
(10) Pub. No.: US 2025/0351010 A1
(43) Pub. Date: Nov. 13, 2025

(54) EPS (4G) FALLBACK

(71) Applicant: DISH Wireless L.L.C., Littleton, CO (US)

(72) Inventor: Xiaowen Robinson, Great Falls, VA (US)

(21) Appl. No.: 18/657,258

(22) Filed: May 7, 2024

(51) Int. Cl. H04W 36/00; H04W 8/02; H04W 40/02; H04W 76/10

(52) U.S. Cl. CPC H04W 36/0022; H04W 8/02; H04W 40/02; H04W 76/10

(57) ABSTRACT

A method may include receiving a request for a 5G voice call, the request associated with a UE associated with the 5G network. The method may include establishing a voice session within the 5G network. The method may include determining that the 5G voice call cannot be established by the 5G network and/or the roaming network. The method may include transmitting data used to generate a fall back voice session with the UE and within 5G network and/or the roaming network. The method may include configuring the voice session within 5G network to allow voice data to be handled within the fall back voice session of the roaming network in conjunction with the voice session within the roaming network. The method may include transmitting the voice data to the user equipment via the 5G network and the roaming network to establish the 5G voice call.

### BACKGROUND

As new cellular networks and protocols expand, not all network providers may offer the same capabilities. Different network providers may enter into partnerships where some capabilities are provided to a user equipment associated with a first network provider by some a second network provider. When the first and second network providers have varying capabilities, however, cellular services must still be provided so that the UE does not experience a drop in quality or failure in service.

### BRIEF SUMMARY

A method of home routing a voice call via a 5G network and a roaming network may include receiving, by one or more components of the 5G network, a request for a 5G voice call, the request associated with a user equipment (UE) associated with the 5G network. The method may include establishing, by the one or more components of the 5G network, a voice session within the 5G network. The method may include determining, by the one or more components of the 5G network, that the 5G voice call cannot be established by the 5G network and/or the roaming network. The method may include transmitting, by the one or more components of the 5G network, data used to generate a fall back voice session with the UE and within 5G network and/or the roaming network. The method may include configuring, by the one or more components of the 5G network, the voice session within 5G network to allow voice data to be handled within the fall back voice session of the roaming network in conjunction with the voice session within the roaming network, such that the 5G voice call is home routed. The method may include transmitting the voice data to the user equipment via the 5G network and the roaming network such that the 5G voice call is established.

In some embodiments, the 5G network is a home network of the user equipment, and the roaming network may include a 5G core, a 4G core, and a 4G radio access network. The request for the 5G voice call may be received by the one or more components of the 5G network from the 5G core of the roaming network, the method may include updating, by the one or more components of the 5G network, the voice session of the user equipment within the 5G network. The method may include receiving, by the one or more components of the roaming network and the 5G network, the voice data from the 4G radio access network and the 4G core of the roaming network via a user plane of the roaming network and the 5G network.

In some embodiments, the request for the 5G voice call is received from the one or more components of the 5G network. The method may include transmitting, by the one or more components of the 5G network, a request for a voice session to the roaming network. The method may include updating, by the one or more components of the 5G network, the voice session of the user equipment to permit the voice data to be routed through 5G core of the 5G network and the 4G core of the roaming network. The method may include receiving, by the one or more components of the 5G network, the voice data from a 4G core and the 4G radio access of the roaming network. The roaming network may be a hybrid 5G network. A session management function and a user plane function of the 5G network may include an evolved packet system capability. The 5G network may be implemented using an open radio access network. The 5G network may be implemented on a cloud-based architecture. The fall back voice session may utilize an enhanced packet system.

A system may include one or more processors and a computer-readable medium may include instructions that, when executed by the system, cause the system to perform operations. According to the operations, the system may receive, by one or more components of a 5G network, a request for a 5G voice call, the request associated with a user equipment (UE) associated with the 5G network. The system may establish by the one or more components of the 5G network, a voice session within the 5G network. The system may determine, by the one or more components of the 5G network, that the 5G voice call cannot be established by the 5G network and/or a roaming network. The system may transmit, by the one or more components of the 5G network, data used to generate a fall back voice session with the UE and within 5G network and/or the roaming network. The system may configure, by the one or more components of the 5G network, the voice session within 5G network to allow voice data to be handled within the fall back voice session of the roaming network in conjunction with the voice session within the roaming network, such that the 5G voice call is home routed. The system may transmit the voice data to the user equipment via the 5G network and the roaming network such that the 5G voice call is established.

In some embodiments, the 5G network is a home network of the user equipment, and the roaming network may include a 5G core, a 4G core, and a 4G radio access network. The request for the 5G voice call may be received by the 5G network from the 5G core of the roaming network. The system may update, by the one or more components of the 5G network, the voice session of the user equipment within the 5G network. The system may receive, by the one or more components of the roaming network and the 5G network, the voice data from the 4G radio access network and the 4G core of the roaming network via a user plane of the roaming network and the 5G network.

In some embodiments, the request for the 5G voice call may be received from the one or more components of the 5G network. The system may transmit, by the one or more components of the 5G network, a request for a voice session to the roaming network. The system may update, by the one or more components of the 5G network, the voice session of the user equipment to permit the voice data to be routed through 5G core of the 5G network and the 4G core of the roaming network. The system may receive, by the one or more components of the 5G network, the voice data from the 4G core and the 4G radio access network of the roaming network. The roaming network may be a hybrid 5G network. The 5G network may be implemented using an open radio access network. The 5G network is implemented on a cloud-based architecture. The fall back voice session may utilize an enhanced packet system.

A non-transitory computer-readable medium may include instructions that, when executed by one or more processors, cause the one or more processors to perform 4G. The 4G may include receiving, by one or more components of the 5G network, a request for a 5G voice call, the request associated with a user equipment (UE) associated with the 5G network. The operations may include establishing, by the one or more components of the 5G network, a voice session within the 5G network. The operations may include determining, by the one or more components of the 5G network, that the 5G voice call cannot be established by the 5G network and/or the roaming network. The operations may include transmitting, by the one or more components of the 5G network, data used to generate a fall back voice session with the UE and within 5G network and/or the roaming network. The operations may include configuring, by the one or more components of the 5G network, the voice session within 5G network to allow voice data to be handled within the fall back voice session of the roaming network in conjunction with the voice session within the roaming network, such that the 5G voice call is home routed. The operations may include transmitting the voice data to the user equipment via the 5G network and the roaming network such that the 5G voice call is established.

In some embodiments, the 5G network is a home network of the user equipment, and the roaming network may include a 5G core, a 4G core, and a 4G radio access network. The request for the voice call may be received by the 5G network from the 5G core of the roaming network, the operations may include. The operations may include updating, by the one or more components of the 5G network, the voice session of the user equipment within the 5G network. The operations may include receiving, by the one or more components of the roaming network and the 5G network, the voice data from the 4G radio access network and the 4G core of the roaming network via a user plane of the roaming network and the 5G network.

### BRIEF DESCRIPTION OF THE DRAWINGS

FIG. 1A illustrates an embodiment of a cellular network system, according to certain embodiments.

FIG. 1B illustrates an exemplary core, according to certain embodiments.

FIG. 2 illustrates an embodiment of a cellular network core network topology as implemented on a public cloud-computing platform, according to certain embodiments.

FIG. 3 illustrates a system for home routing a voice call using an EPS fallback from a roaming network, according to certain embodiments.

FIG. 4 illustrates a process flow for a process for home routing a voice call using EPS fall back provided by a roaming network, according to certain embodiments.

FIG. 5 illustrates a system for providing an EPS fall back to a UE within a home network, according to certain embodiments.

FIG. 6 illustrates a process flow for a process for providing voice services using an EPS fall back provided by a roaming network, according to certain embodiments.

FIG. 7 illustrates a flowchart of a method for providing voice services using EPS fallback, according to certain embodiments.

### DETAILED DESCRIPTION

5G voice services may be provided by Voice Over New Radio (VoNR). VoNR may be dependent on all network components and functions in a communication chain being handled by a 5G radio access network and standalone core. During a VoNR call, voice data is handled via voice over IP connections (e.g., VoIP), and the IP connection is managed by the 5G network. Voice calls provided via VoNR may have better quality and reliability due to reduced latency and a more uniform standard available to wireless network providers. However, to meet voice call required quality including IP connection latency, jitter, etc, the 5G network has to support the specific QoS flows over the radio access system and it may take time to develop the capability. Older standards such as Long-Term Evolution (LTE) standards are still used to support voice service known as Voice over LTE (VOLTE). For faster rollout of the 5G deployment to take advantage of the 5G benefits on data service, VoLTE is leveraged for voice service in the short term.

The adoption of 5G wireless standards has not been done at an equal pace by all wireless network providers in all areas. Some wireless network providers may have some 5G infrastructure built on top of or in addition to other protocols (e.g., 4G LTE, 3G, etc.). Thus, these wireless network providers may provide some services (e.g., data) to user equipment (UE) via 5G standards, but not include a standalone 5G core (and therefore cannot utilize VoNR for voice calls). Other wireless network providers may have built a standalone 5G wireless network from the ground up, enabling VoNR calls. Yet other wireless network providers may have enabled a 5G core, but not have VoNR, LTE, or other infrastructure to provide voice services to UEs. Furthermore, wireless network providers of either type may not provide coverage over all regions. The wireless network providers may, however, still desire to provide coverage to associated UEs, enabling the UEs to access some or all of the services offered by the wireless service provider.

For example, a first wireless service provider may provide a standalone 5G wireless network, where all services (e.g., voice and data) are provided via a 5G network. A UE associated with the first wireless network provider may be out of a service area of the first wireless network provider, but still wishes to make a voice call. The UE may then connect to a second wireless network provider in order to place the voice call. The second wireless network provider may be a roaming partner of the first wireless network provider, but not have VoNR capabilities. Thus, the UE may not be able to complete the voice call using the 5G standards, even though the UE is associated with the standalone 5G network. Furthermore, the second wireless network provider may need to route the call using some or all of the network functions of the first wireless network provider (e.g., to validate the UE, use the appropriate charging function, properly route a call, etc.). In another example, the first wireless network provider may provide 5G services, but not be able to complete a 5G voice call as the wireless network provider may not administer a RAN tuned to provide VoNR. The UE may then attempt to make a 5G voice call but be unable to do so. The first wireless network may then utilize the second wireless network provider to provide voice services to the UE over LTE.

In the above examples, the UE associated with the first wireless network (i.e., the UE's home network), which has 5G only, may attempt to place a 5G voice call using VoNR in its home 5G network but is unable to because the home network is unable to provide VoNR services. Instead, the request for the 5G voice call is routed through a roaming partner of the first wireless network (e.g., the second wireless network) using the 4G RAN of the roaming partner network, which may have 4G only or have both 4G and 5G networks. In this case, the voice call initiated from the 5G home network may “fall back” to the 4G RAN of the second wireless network in order to complete the voice call. Additionally, because the UE is attempting to place a 5G voice call over 5G IP connection, the voice call is a VoIP call and voice call falls back to the 4G RAN using EPS IP connection (being a VoIP standard). This process may therefore be referred to as an EPS fall back (EPSFB).

EPSFB may present its own issues when falling back to a roaming partners network. In order to provide voice services to a UE, a wireless network provider may perform certain tasks such as verifying subscriber information (e.g., phone numbers, account identifiers, account levels, etc.), session creation and management, location services, etc. When the UE is connected to the RAN of a roaming partner (i.e., the UE is “visiting” a wireless network), some or all of these functions may be handled by the roaming partner. For example, the roaming partner may receive a request to make a voice call from the UE, contact the home network of the UE to verify a subscriber status of the UE, then create and manage a session for the voice call. However, because the roaming partner is handling the session and other processes of the voice call, changes made to a subscriber status may not populate to the roaming partner correctly, charging functions may not be accurate, and other such errors may occur. It may be preferred, therefore, to have the voice call home routed, or handled by the 5G core of the home network associated with the UE. Home routing the voice call may provide for more efficient use of resources in validating subscriber information, various charging functions, session management, and other such processes. Thus, there is a need to efficiently provide home routing of 5G voice calls during a 4G EPS fallback.

In one example, a UE may be connected to a roaming network. The roaming network may have an agreement with a 5G network associated with the UE (e.g., a home network). The roaming network may include a 5G core for data applications and a 4G core for voice applications. While using the roaming network for data, therefore, the UE may be connected to the 5G core of the roaming network and home routed to the 5G network. Then, the UE may desire to place or receive a voice call. The 5G core of the roaming network may then receive a request of the QoS flow setup for the voice call from the 5G network and forward the request to the 5G RAN of the roaming network. Instead of establishing the request QoS flow, the 5G RAN of the roaming network may reject the request. Subsequently, the 5G core of the roaming network (or a component(s) thereof) may determine that the voice call may not be established using a 5G radio access network (RAN) of the roaming network (e.g., because the roaming network 5G RAN does not support the QoS flow for voice service). The 5G core of the roaming network may then initiate a fall back to a 4G EPS i.e LTE RAN and/or core of the roaming network. The data session for the voice call in the 5G core of the home network may then be updated, such that the voice call is home routed from the 4G RAN of the roaming network through the 5G core of the home network. The UE may then complete the voice call.

In another example, the UE may be in a service area of the home network and be connected to the 5G core of the home network (and therefore have an active session within the 5G core). The UE may then request or receive a voice call. However, the home network 5G RAN may not support voice service within the service area. The 5G RAN and core of the home network (or a component(s) thereof) may therefore initiate a fall back to the 4G EPS and 4G core of the roaming network. The 5G core of the home network may then update the active session such that 5G core of the home network may receive voice data from the 4G RAN and core of the roaming network. The UE may then connect to the 4G RAN of the roaming network, and the voice call may be completed.

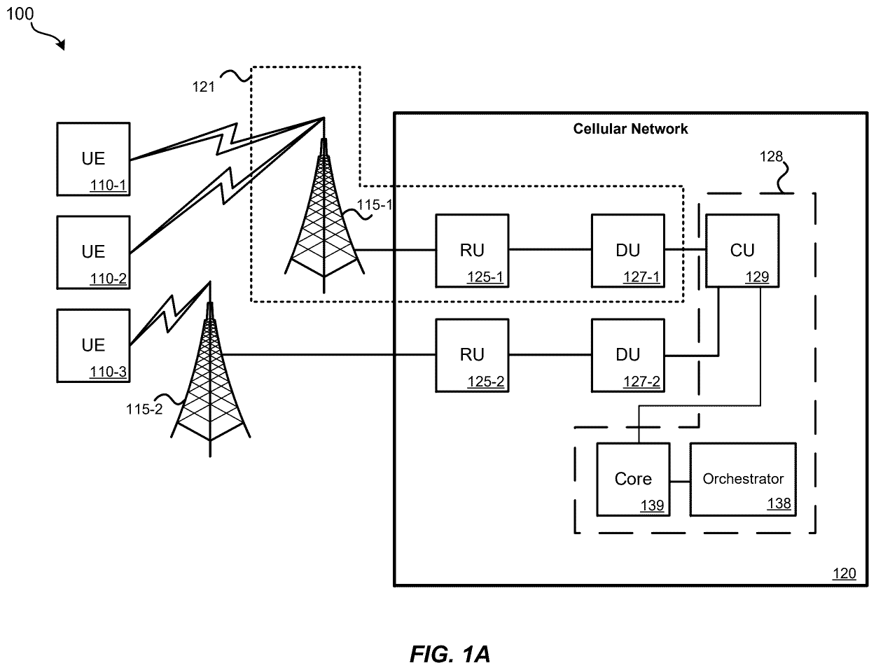

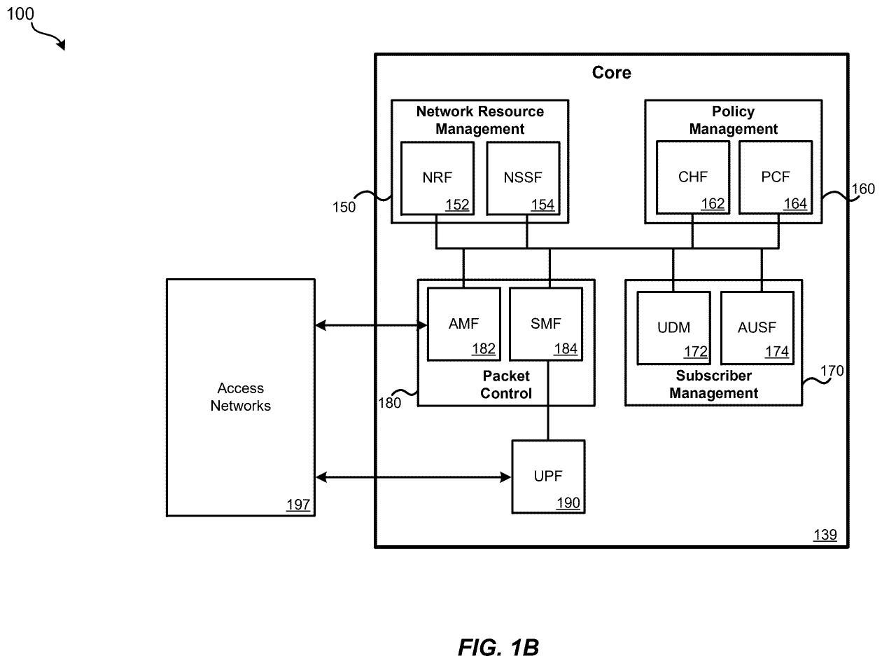

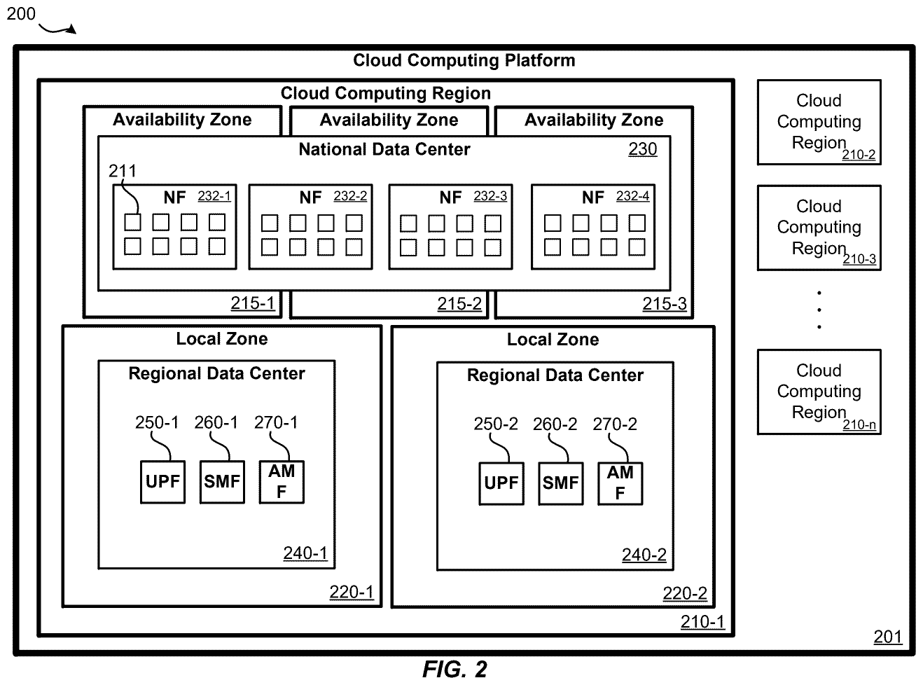

FIG. 1A illustrates an embodiment of a cellular network system 100 (“system 100”), according to certain embodiments. System 100 can include a fifth generation (5G) New Radio (NR) cellular network; other types of cellular networks, such as fourth generation (4G) long-term evolution (LTE) cellular network, sixth generation (6G) cellular network, seventh generation (7G) cellular network, etc. are also possible. System 100 can include: UE 110 (UE 110-1, UE 110-2, UE 110-3); base station 115; cellular network 120; radio units 125 (“RUs 125”); distributed units 127 (“DUs 127”); centralized unit 129 (“CU 129”); core 139, and orchestrator 138. FIG. 1A represents a component level view. In a virtualized open radio access network (O-RAN), because components can be implemented as software in the cloud, except for components that receive and transmit RF, the functionality of various components can be shifted among different servers, for which the hardware may be maintained by a separate (e.g., public) cloud-service provider, to accommodate where the functionality of such components is needed, such as detailed in relation to FIG. 2.

UE 110 can represent various types of end-user devices, such as smartphones, cellular modems, cellular-enabled computerized devices, sensor devices, manufacturing equipment, gaming devices, access points (APs), any computerized device capable of communicating via a cellular network, etc. UE can also represent any type of device that has incorporated a cellular (e.g., 5G) interface, such as a 5G modem. Examples include sensor devices, Internet of Things (IoT) devices, manufacturing robots; unmanned aerial (or land-based) vehicles, network-connected vehicles, environmental sensors, etc. UE 110 may use RF to communicate with various base stations of cellular network 120. Two base stations 115 (BS 115-1, 115-2) are illustrated. Real-world implementations of system 100 can include many (e.g., hundreds, thousands) base stations, and many RUs, DUs, and CUs. BS 115 can include one or more antennas that allow RUs 125 to communicate wirelessly with UEs 110. RUs 125 can represent an edge of cellular network 120 where data is transitioned to wireless communication. In some implementations, the radio access technology (RAT) used by RU 125 is 5G New Radio (NR). Other implementations use other RAT, such as 4G Long Term Evolution (LTE). The remainder of cellular network 120 may be based on an exclusive 5G architecture, a hybrid 4G/5G architecture, a 4G architecture, or some other cellular network architecture. Base station equipment 121 may include an RU (e.g., RU 125-1) and a DU (e.g., DU 127-1) located on site at the base station. In some embodiments, the DU may be physically remote from the RU. For instance, multiple DUs may be housed at a central location and connected to geographically distant (e.g., within a couple of kilometers) RUs.

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, “band 71” (a radiofrequency band near 600 Megahertz allocated for cellular communications). One or more DUs, such as DU 127-1, may communicate with CU 129. Collectively, RUs, DUs, and CUs create a gNodeB, which serves as the radio access network (RAN) of cellular network 120. CU 129 can communicate with core 139. The specific architecture of cellular network 120 can vary by embodiment. Edge cloud server systems outside of cellular network 120 may communicate, either directly, via the Internet, or via some other network, with components of cellular network 120. For example, one or more DUs 127-1 may be able to communicate with an edge cloud server system without routing data through CU 129 or core 139.

At a high level, the various components of a gNodeB can be understood as follows: RUs perform RF-based communication with UE. DUs support lower layers of the protocol stack such as the radio link control (RLC) layer, the medium access control (MAC) layer, and the physical communication layer. CUs support higher layers of the protocol stack such as the service data adaptation protocol (SDAP) layer, the packet data convergence protocol (PDCP) layer and the radio resource control (RRC) layer. A single CU can provide service to multiple co-located or geographically distributed DUs. A single DU can communicate with multiple RUs.

Further detail regarding exemplary core 139 is provided in relation to FIG. 1B. FIG. 1B illustrates an exemplary core 139, according to certain embodiments. The exemplary core 139 can be physically distributed across data centers or located at a central national data center (NDC), such as detailed in relation to FIG. 2, can perform various core functions of the cellular network. Core 139 can include: network resource management components 150; policy management components 160; subscriber management components 170; and packet control components 180. Individual components may communicate via a bus, thus allowing various components of core 139 to communicate with each other directly. Core 139 is simplified to show some key components. Implementations can involve additional components.

Network resource management components 150 can include: Network Repository Function (NRF) 152 and Network Slice Selection Function (NSSF) 154. NRF 152 can allow 5G network functions (NFs) to register and discover each other via a standards-based application programming interface (API). NSSF 154 can be used by AMF 182 to assist with the selection of a network slice that will serve a particular UE (e.g., UEs 110 of FIG. 1A).

Policy management components 160 can include: Charging Function (CHF) 162 and Policy Control Function (PCF) 164. CHF 162 allows charging services to be offered to authorized network functions. Converged online and offline charging can be supported. PCF 164 allows for policy control functions and the related 5G signaling interfaces to be supported.

Subscriber management components 170 can include: Unified Data Management (UDM) 172 and Authentication Server Function (AUSF) 174. UDM 172 can allow for generation of authentication vectors, user identification handling, NF registration management, and retrieval of UE individual subscription data for slice selection. AUSF 174 performs authentication with UEs.

Packet control components 180 can include: Access and Mobility Management Function (AMF) 182 and Session Management Function (SMF) 184. AMF 182 can receive connection-and session-related information from UEs and is responsible for handling connection and mobility management tasks. SMF 184 is responsible for interacting with the decoupled data plane, creating updating and removing Protocol Data Unit (PDU) sessions, and managing session context with the User Plane Function (UPF).

User plane function (UPF) 190 can be responsible for packet routing and forwarding, packet inspection, quality of service (QOS) handling, and external PDU sessions for interconnecting with a Data Network (DN) (e.g., the Internet) or various access networks 197. Access networks 197 can include the RAN of cellular network 120 of FIG. 1A.

While FIGS. 1A and 1B illustrate various components of cellular network 120, it should be understood that other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In a virtualized arrangement, specialized software on general-purpose hardware may be used to perform the functions of components such as DU 127, CU 129, and core 139. Functionality of such components can be co-located or located at disparate physical server systems. For example, certain components of core 139 may be co-located with components of CU 129.

Returning to FIG. 1A, some O-RAN implementations of the DUs 127, CU 129, core 139, and/or orchestrator 138 are implemented virtually as software being executed by general-purpose computing equipment, such as in a data center. Therefore, depending on needs, the functionality of a DU, CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100, cloud-based cellular network components A128 include CU 129, core 139, and orchestrator 138. In some embodiments, DUs 127 may be partially or fully added to cloud-based cellular network components 128. Such cloud-based cellular network components 128 may be executed as specialized software executed by underlying general-purpose computer servers. Cloud-based cellular network components 128 may be executed on a public third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested. A “public” cloud-based computing platform refers to a platform where various unrelated entities can each establish an account and separately utilize the cloud computing resources, the cloud computing platform managing segregation and privacy of each entity's data.

Kubernetes, or some other container orchestration platform, can be used to create and destroy the logical DU, CU, or 5G core units and subunits, as needed, for the cellular network 120 to function properly. Kubernetes allows for container deployment, scaling, and management. As an example, if cellular traffic increases substantially in a region, an additional logical DU or components of a DU may be deployed in a data center near where the traffic is occurring without any new hardware being deployed; rather, processing and storage capabilities of the data center would be devoted to the needed functions. When the need for the logical DU or subcomponents of the DU no longer exists (i.e., when traffic subsequently decreases), Kubernetes can allow for removal of the logical DU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new DU, orchestrator 138 can perform a pipeline of calling the DU code from a software repository incorporated as part of, or separate from, cellular network 120; pulling corresponding configuration files (e.g., helm charts); creating Kubernetes nodes/pods; loading DU containers; configuring the DU; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet particular service level agreement (SLA) levels and parameters. By controlling the location and amount of computing and communication resources allocated to a network slice, the SLA attributes for UE on the network slice can be varied on different slices. A network slice can be configured to provide sufficient resources for a particular application to be properly executed and delivered (e.g., gaming services, video services, voice services, location services, sensor reporting services, data services, etc.). However, such allocations also account for resource limitations, such as to avoid allocation of an excess of resources to any particular UE group and/or application. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1; and a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

As illustrated in FIG. 1A, UE 110 may be operating on one or more production slices of cellular network 120. As detailed later in this document, a UE that functions on a particular entity's local network may be assigned to a slice particular to the entity or a slice that provides a particular QoE for tasks to be performed by the entity's UE.

Components such as DUs 127, CU 129, orchestrator 138, and core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

FIG. 2 illustrates an embodiment of a cellular network core network topology 200 as implemented on a public cloud-computing platform, according to certain embodiments. The cellular network core network topology 200 can be an implementation of the core 139 of FIG. 1A and/or 1B. Cellular network core network topology 200 can represent how logical cellular network groups are distributed across cloud computing infrastructure of cloud computing platform 201. Cloud computing platform 201 can be logically and physically divided up into various different cloud computing regions 210. Each of cloud computing regions 210 can be isolated from other cloud computing regions to help provide fault tolerance, fail-over, load-balancing, and/or stability and each of cloud computing regions 210 can be composed of multiple availability zones, each of which can be a separate data center located in general proximity to each other (e.g., within 600 miles). Further, each of cloud computing regions 210 may provide superior service to a particular geographic region based on physical proximity. For example, cloud computing region 210-1 may have its datacenters and hardware located in the northeast of the United States while cloud computing region 210-2 may have its datacenters and hardware located in California. For simplicity, the details of the cellular network as executed in only cloud computing region 210-1 is illustrated. Similar components may be executed in other cloud computing regions of cloud computing regions 210 (210-2, 210-3, 210-n).

In other embodiments, cloud computing platform 201 may be a private cloud computing platform. A private cloud computing platform may be maintained by a single entity, such as the entity that operates the hybrid cellular network. Such a private cloud computing platform may be only used for the hybrid cellular network and/or for other uses by the entity that operates the hybrid cellular network (e.g., streaming content delivery).

Each of cloud computing regions 210 may include multiple availability zones 215. Each of availability zones 215 may be a discrete data center or group of data centers that allows for redundancy that allows for fail-over protection from other availability zones within the same cloud computing region. For example, if a particular data center of an availability zone experiences an outage, another data center of the availability zone or separate availability zone within the same cloud computing region can continue functioning and providing service. A logical cellular network component, such as a national data center, can be created in one or across multiple availability zones 215. For example, a database that is maintained as part of NDC 230 may be replicated across availability zones 215; therefore, if an availability zone of the cloud computing region is unavailable, a copy of the database remains up-to-date and available, thus allowing for continuous or near continuous functionality.

On a (e.g., public) cloud computing platform, cloud computing region 210-1 may include the ability to use a different type of data center or group of data centers, which can be referred to as local zones 220. For instance, a client, such as a provider of the hybrid cloud cellular network, can select from more options of the computing resources that can be reserved at an availability zone 215 compared to a local zone 220. However, a local zone 220 may provide computing resources nearby geographic locations where an availability zone 215 is not available. Therefore, to provide low latency, certain network components, such as regional data centers 240, can be implemented at local zones 220 rather than availability zones 215. In some circumstances, a geographic region can have both a local zone 220 and an availability zone 215.

In the topology of a 5G NR cellular network, 5G core functions of core 139 can logically reside as part of a national data center (NDC) 230. NDC 230 can be understood as having its functionality existing in cloud computing region 210-1 across multiple availability zones 215. At NDC 230, various network functions, such as NFs 232, are executed. For illustrative purposes, each NF 232, whether at NDC 230 or elsewhere located, can be comprised of multiple sub-components, referred to as pods (e.g., pod 211) that are each executed as a separate process by the cloud computing region 210. The illustrated number of pods 211 is merely an example; fewer or greater numbers of pods 211 may be part of the respective 5G core functions. It should be understood that in a real-world implementation, a cellular network core, whether for 5G or some other standard, can include many more network functions. By distributing NFs 232 across availability zones 215, load-balancing, redundancy, and fail-over can be achieved. In local zones 220, multiple regional data centers 240 can be logically present. Each of regional data centers 240 may execute 5G core functions for a different geographic region or group of RAN components. As an example, 5G core components that can be executed within an RDC, such as RDC 240-1, may be: UPFs 250, SMFs 260, and AMFs 270. While instances of UPFs 250 and SMFs 260 may be executed in local zones 220, SMFs 260 may be executed across multiple local zones 220 for redundancy, processing load-balancing, and fail-over.

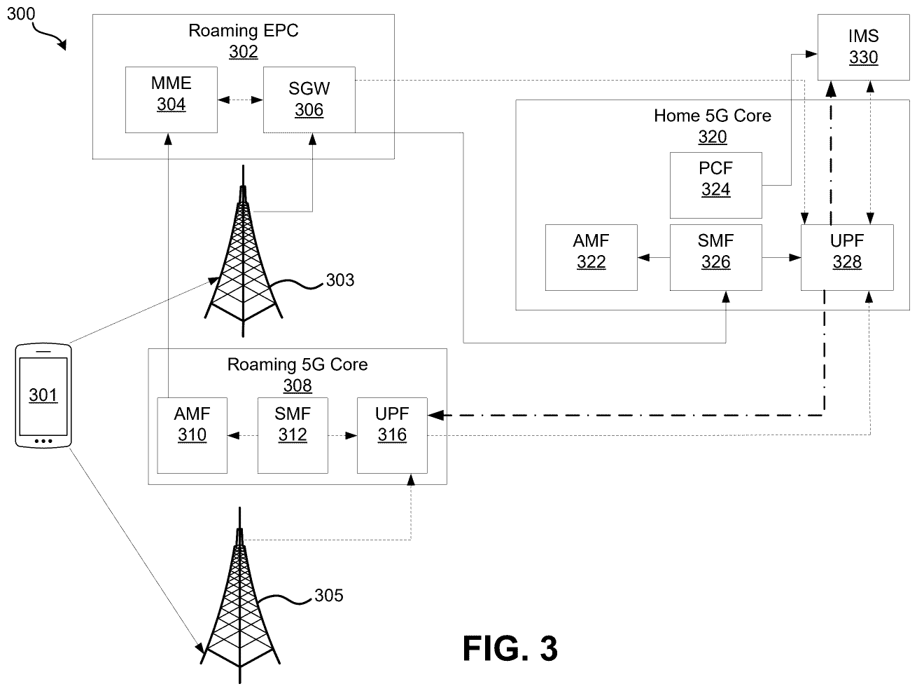

FIG. 3 illustrates a system 300 for home routing a voice call using an EPS fallback from a roaming network, according to certain embodiments. The system 300 may include a UE 301, a roaming Enhanced Packet Core (EPC) 302, a roaming 5G core 308, and a home 5G core 320. The EPC 302 may be at least a portion of a 4G core and include components such as a mobility management entity (MME) 304 and a serving gateway (SGW) 306. It should be understood that the EPC 302 may include other components and/or network functions not shown in FIG. 3. The EPC 302 may also be associated with and/or connected to an eNodeB (sometimes “4G RAN”) 303. The roaming 5G core 308 may include an AMF 310, an SMF 312, and a UPF 316. It should be understood that the roaming 5G core 308 may include other components and/or network functions not shown in FIG. 3 (e.g., any and/or all of the components and functions described in relation to FIGS. 1A-2). The roaming 5G core 308 may be associated with a gNodeB 305. The EPC 302, 4G RAN 303, and roaming 5G core 308 may all be included in a roaming network, meaning that while the UE 301 may be connected to some or all of the components of the roaming network, the UE 301 is not associated with a network provider of the roaming network.

The home 5G core 320 may be similar to the exemplary core 139 in FIG. 1B and include an AMF 322, a PCF 324, an SMF 326, and a UPF 328. The home 5G core 320 may be in communication with an Internet Protocol Multimedia Subsystem (IMS) 330. The home 5G core 320 and IMS 330 may be included in a home network. The UE 301 may be a customer and/or account holder of a network provider associated with the home network. The home 5G core 320 (and/or other components of the home network) may be implemented via an open radio access network (ORAN). Some or all of the home 5G core 320 may be implemented in a cloud-based architecture. In some embodiments, the home network may be a standalone 5G network.

As shown in FIG. 3, the UE 301 may not be connected to the home 5G core 320. For example, the UE 301 may be outside of a service area of the home network provider. Instead, the UE 301 may be connected to the roaming 5G RAN 305 for services such as data, location services, etc. Because the UE 301 is already connected to the roaming 5G RAN 305, one or more of the network functions of the roaming 5G core 308 may have already established a home routed session for the services provided by the roaming network provider. For example, the SMF 312 may have sent a PDU session request to the AMF 322 to be initiated by the SMF 326. The SMF 326 may then cause the PDU session to be initiated and registered with the IMS 330. The PDU session may be identified with a data name network (DNN), such as a data DNN. Within the PDU session, the UE 301 may access data services provided by the roaming network provider via the UPF 316 of the roaming 5G core and the UPF 328 of the home 5G core.

At some point, the UE 301 may request a voice call via the 5G RAN 303. The request may be transmitted to the AMF 322 of the home 5G core 320 via the UPF 316 of the roaming 5G core and the UPF 328 of the home 5G core. The AMF 322 may verify one or more characteristics of the UE 301 such as a device identifier, account identifier, network provider associated, and other such characteristics. For example, the AMF 322 (either alone or in conjunction with another network function of the home 5G core 320) may verify that the UE 301 is permitted to make voice calls and determine that the UE 301 is included in an agreement or other arrangement that allows voice calls to be placed by the UE 301 via the roaming network. Then, the AMF 322 (and/or the SMF 326) may cause the PDU session to be updated in the IMS 330 to indicate a voice DNN. Because the request for the voice call originated from the UE 301 while connected to the roaming network (e.g., the roaming 5G core 308 and/or the 5G RAN 305), the PDU session may indicate a remote node (e.g., the SMF 312 of the roaming 5G core 308) and a local node (e.g., the SMF 326 of the home 5G core 320). In other words, the PDU session may be set to originate from the remote node, but be routed to the local node, home routing the voice call.

Other network functions of the home 5G core 320 may then perform other functions in order to enable the voice call. For example, a Packet Core Gateway (PGW) of the UPF 328 may be recruited to accept voice data from a corresponding component of the roaming 5G core 308. The PCF 324 and/or the SMF 326 may establish dedicated one or more QoS flows in order to create resource reservations for the voice call (e.g., establishing a barrier, etc.). Other operations to set up and/or complete a voice call may be performed by these and other network functions of the home 5G core 320.

The AMF 310 may then transmit a request to the roaming 5G core 308 to update an associated PDU session to indicate a voice DNN. However, the 5G RAN 305 may not be configured to support VoNR. In other words, the roaming network cannot provide a 5G voice call. Then, the gNodeB may reject the request and indicate that the voice call should be completed using an EPS fall back procedure. Then, the AMF 310 and/or the SMF 312 may update the associated session to indicate that the voice call may be performed via EPC (i.e., 4G). The UE 301 may then be handed over to the 4G RAN 303. The AMF 310 may then communicate with the MME 304 to establish a session within the roaming EPC 302. The PDU session within the IMS 330 (and/or the SMF 326) may then be updated such that the MME 304 (or some other component of the roaming EPC 302) is the remote node. During the voice call, the UE 301 may transmit voice data through the 4G RAN 303. The SGW 306 may then transmit the voice data to the UPF 328 (e.g., the PGW-U) such that the voice call may be completed. Because the local node is within the home 5G core of the home network, the voice call may be home routed, with the appropriate charging functions and other policies managed and applied at the local node instead of by the remote node (e.g., the roaming network).

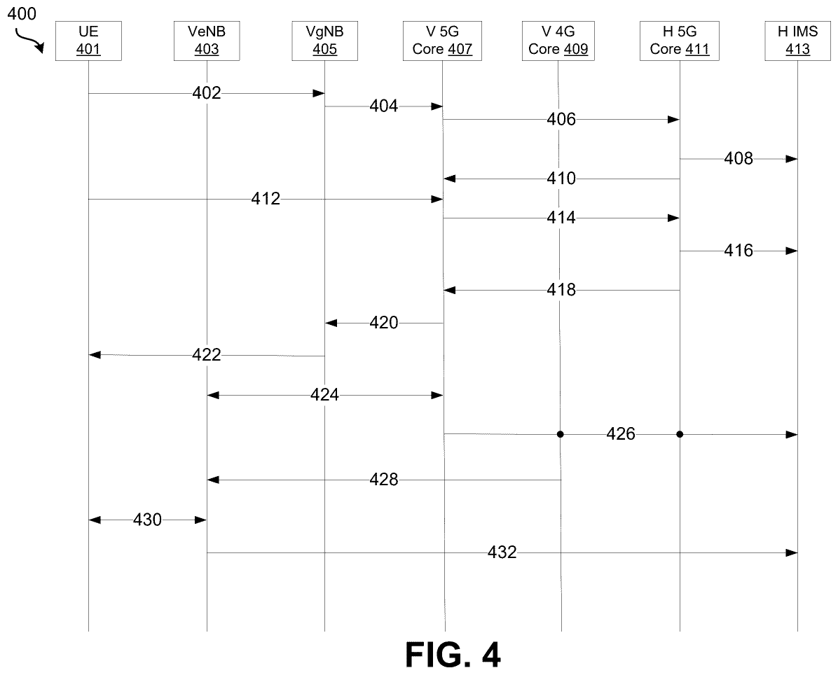

FIG. 4 illustrates a process flow for a process 400 for home routing a voice call using EPS fall back provided by a roaming network, according to certain embodiments. The process 400 may be performed by some or all of the systems and devices described in FIGS. 1A-3. Thus, devices and systems described in relation to FIG. 4 may include similar properties and capabilities as those described in relation to FIGS. 1A-3.

At 402, a UE 401 may connect to a visiting gNodeB (VgNB) 405. The UE 401 may be similar to the UE 301 in FIG. 3. The VgNB 405 may be similar to (or a component of) the roaming RAN 303. The UE 401 may be associated with a home network, but be out of a service area of the home network and in a service area of a visiting network. The VgNB 405 may be configured to provide 5G data services to UEs, but not configured to provide VoNR.

At 404, the VgNB 405 may transmit data to a visiting 5G core 407, causing a PDU session to be created for the UE 401. The visiting 5G core 407 may include one or more network functions, such as an IMS, AMF, SMF, PCF, etc. Thus, actions performed by the visiting 5G core 407 should be understood to mean that one or more network functions included in the visiting 5G core 407 are performing the actions. The PDU session may indicate an IMS DNN, where data (e.g., internet access) may be provided to the UE 401. The visiting 5G core 407 may also determine that the UE 401 is associated with the home network. The visiting 5G core 407 (or component thereof) may determine a QoS flow (e.g., QoS flow 1) to home route the PDU session to the home network.

At 406, using the QoS flow, the visiting 5G core 407 may transmit data to a home 5G core 411. The home 5G core 411 may include one or more network functions, such as an IMS, AMF, SMF, PCF, etc. Actions performed by the home 5G core 411 should be understood to mean that one or more network functions included in the home 5G core 411 are performing the actions. The home 5G core 411 may use some or all of the data to initiate a PDU session corresponding to the PDU session created by the visiting 5G core 407. For example, the AMF may transmit data to the SMF, PCF, and/or components of the UPF (e.g., a PGW-U) in order to enable the session. Various components of the home 5G core 411 may also authenticate the UE 401 (e.g., an account status, level, etc.).

Then, at 408, the home 5G core 411 may complete registration of the UE 401 by creating the PDU session in a home IMS 413. The PDU session may indicate the IMS DNN, such that data may be provided to the UE 401 via the home 5G core 411 and the visiting 5G core 407. At 410, data associated with the UE 401 and/or the PDU session may be transmitted to the visiting 5G core 407 by the home 5G core 411. The data may indicate an account associated with the UE 401, routing information, and other such data.

At 412, the UE 401 may request a 5G voice call (e.g., VoIP) from the visiting 5G core 407. The visiting 5G core 407 may then update the PDU session to indicate a voice DNN. At 414, the visiting 5G core 407 may transmit some or all of the request (or data based thereon) to the home 5G core 411. Based at least in part on the data included in the request, the home 5G core 411 may reserve resources for the voice call. For example, the AMF, SMF, PCF, etc. may operate together and/or separately according to a QoS flow (e.g., QoS flow 5) to reserve a bearer to enable the voice call, where data may be routed via the UPF of the home 5G core 411 to the UPF of the visiting 5G core 407 (and, theoretically, through a 5G RAN and to the UE 401). Additionally or alternatively, the home 5G core 411 may determine a local node (e.g., the SMF of the home 5G core 411) and a remote node (e.g., the SMF of the visiting 5G core 407). Then, at 416, the PDU session in the home IMS 413 may be updated to indicate a voice DNN and/or the local node and the remote node.

At 418, data indicating the updated PDU session (e.g., indicating the remote node and the local node) may be transmitted to the visiting 5G core 407. The PDU session within the visiting 5G core 407 may be updated accordingly. At 420, the visiting 5G core 407 may attempt to initiate the voice call using 5G protocols (e.g., VoNR) from the VgNB 405. However, the VgNB 405 may not be configured to provide VoNR services. Thus, at 422, the VgNB 405 may indicate to the UE 401 that the 5G voice call request has failed, and that an EPS fallback procedure has begun. The VgNB 405 may also release the UE 401 and initiate a redirect to a visiting 4G core 409 and a visiting eNodeB (eNB) 403.

At 424, the VgNB 405 may transmit data rejecting the updated PDU session and indicating that the EPS fall back procedure is to be initiated to the visiting 5G core 407. In response, at 426, the visiting 5G core 407 may use the data to update the PDU session internally. The visiting 5G core 407 may also transmit data to a visiting 4G core 409 such that the PDU session may be routed through one or more network functions of the visiting 4G core 409. The visiting 4G core 409 may include an MME, SGW, and other network functions and components to provide voice services via LTE and/or EPS. Actions performed by the visiting 4G core 409 should be understood to mean that one or more network functions included in the visiting 4G core 409 are performing the actions. The visiting 5G core 407 and/or the visiting 4G core 409 may also transmit data to the home 5G core 411 such that the PDU session within the home IMS 413 is updated to indicate the EPS fallback.

At 430, the UE 401 may begin the voice call using the eNB 403. At 432, voice data associated with the voice call may be routed through the visiting 4G core 409 to the home 5G core 411. The voice data may be at least partially routed through a user plane of both the visiting network and the home network (e.g., from the SGW of the visiting 4G core 409 to the PGW of the home 5G core 411). Thus, the voice call may be home routed to the home network, although initiated using a roaming network using an EPS fall back procedure.

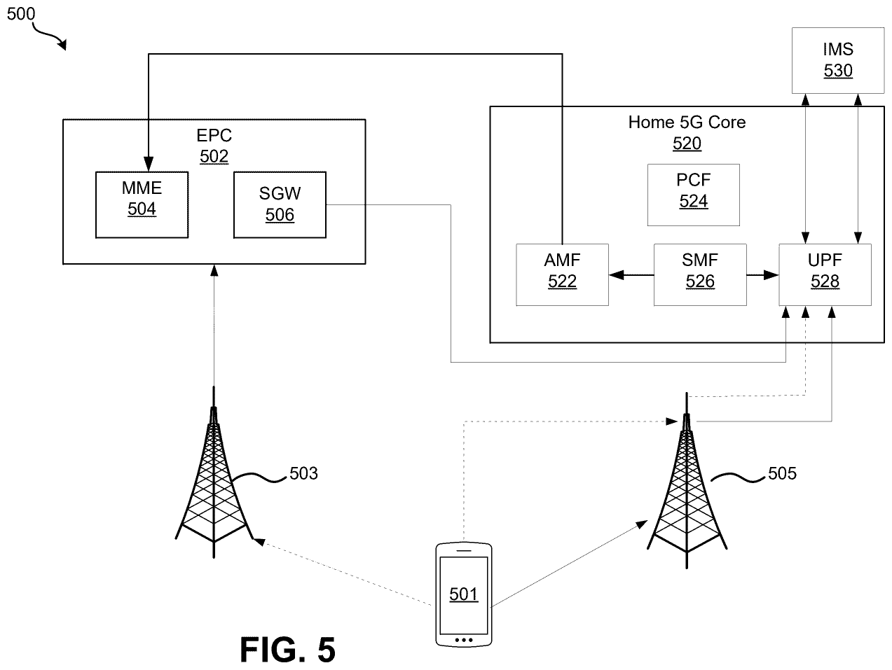

FIG. 5 illustrates a system 500 for providing an EPS fall back to a UE within a home network, according to certain embodiments. The system 500 may be similar to some or all of the system 300 described in FIG. 3. The system 500 may include a UE 501, an roaming Enhanced Packet Core (EPC) 502, and a home 5G core 520. The EPC 502 may be at least a portion of a 4G core and include components such as a mobility management entity (MME) 504 and a serving gateway (SGW) 506. It should be understood that the EPC 502 may include other components and/or network functions not shown in FIG. 3. The EPC 502 may also be associated with and/or connected to an eNodeB (sometimes “4G RAN”) 503. The EPC 502, 4G RAN 503 may be included in a roaming network, meaning that while the UE 501 may be connected to some or all of the components of the roaming network, the UE 501 is not associated with a network provider of the roaming network. In some embodiments, the roaming network may include a 5G core (e.g., the roaming 5G core 308 in FIG. 3).

The home 5G core 520 may be similar to the exemplary core 139 in FIG. 1B and include an AMF 522, a PCF 524, an SMF 526, and a UPF 528. The home 5G core 520 may be in communication with a Internet Protocol Multimedia Subsystem (IMS) 530. The home 5G core 520 and IMS 530 may be included in a home network. The UE 501 may be a customer and/or account holder of a network provider associated with the home network. The home 5G core 520 (and/or other components of the home network) may be implemented via an open radio access network (ORAN). Some or all of the home 5G core 520 may be implemented in a cloud-based architecture. In some embodiments, the home network may be a standalone 5G network.

As shown in FIG. 5, the UE 501 may be connected to the 5G RAN 505 of the home network. Upon connecting to the 5G RAN 505, the SMF 526 may then cause the PDU session to be initiated and registered with the IMS 530 (e.g., via QoS flow 1). The PDU session may be identified with a data name network (DNN), such as an Internet DNN. Within the PDU session, the UE 501 may access data services provided by the roaming network provider via the UPF 528 of the home 5G core 520.

At some point, the UE 501 may request a voice call via the 5G RAN 505. However, the 5G RAN 505 (and/or the 5G core) of the home network may not be configured to provide voice services via VoNR. In other words, the home network may not be able to complete the voice call using the associated systems and devices within the service area. In order to fulfill the request, the one or more components of the home 5G core 520 may then reject the request and initiate an EPS fallback procedure. The request (or data included therein) may be transmitted to the AMF 522 of the home 5G core 520 via the UPF 528. The AMF 522 (and/or other network functions) may verify one or more characteristics of the UE 501 such as a device identifier, account identifier, associated network provider, and other such characteristics. For example, the AMF 522 (either alone or in conjunction with another network function of the home 5G core 520) may verify that the UE 501 is permitted to make voice calls. The AMF 522 (and/or other network functions such as the PCF 524) may then identify a roaming network, capable of completing the voice call via EPS.

Then, the AMF 522 (and/or the SMF 526) may cause the PDU session to be updated in the IMS 530 to indicate a voice DNN. The PDU session may also be updated to identify a local node (e.g., the SMF 526) and a remote node (e.g., the MME 504). Thus, when the voice call is handed over to the EPC 502, the voice call may remain home routed, with various functions performed by the home network instead of a roaming network.

Other network functions of the home 5G core 520 may perform other functions in order to enable the voice call. For example, a Packet Core Gateway (PGW) of the UPF 528 may be recruited to accept voice data from a corresponding component of the roaming 5G core 508. The PCF 524 and/or the SMF 526 may establish dedicated one or more QoS flows in order to create resource reservations for the voice call (e.g., establishing a bearer, etc.). Other operations to set up and/or complete a voice call may be performed by these and other network functions of the home 5G core 520.

The AMF 522 may transmit data to the EPC 502 (e.g., to the MME 504) initiating a PDU session in order to complete the voice call. Once the session is established, the UE 501 may then be handed over to the 4G RAN 503. The AMF 510 may then communicate with the MME 504 to establish a session within the roaming EPC 502. The PDU session within the IMS 530 (and/or the SMF 526) may then be updated such that the MME 504 (or some other component of the roaming EPC 502) is the remote node. During the voice call, the UE 501 may transmit voice data through the 4G RAN 503. The SGW 506 may then transmit the voice data to the UPF 528 (e.g., the PGW-U) such that the voice call may be completed. Because the local node is within the home 5G core of the home network, the voice call may be home routed, with the appropriate charging functions and other policies managed and applied at the local node instead of by the remote node (e.g., the roaming network).

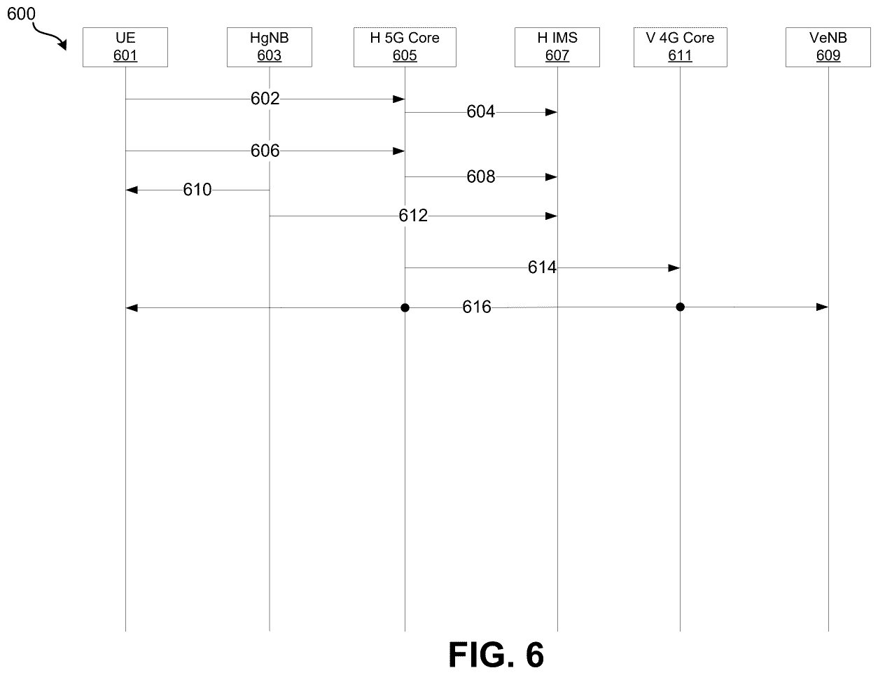

FIG. 6 illustrates a process flow for a process 600 for providing voice services using an EPS fall back provided by a roaming network, according to certain embodiments. The process 600 may be performed by some or all of the systems and devices described in FIGS. 1A-5. Thus, devices and systems described in relation to FIG. 6 may include similar properties and capabilities as those described in relation to FIGS. 1A-5.

602, a UE 601 may connect to a home gNodeB (HgNB) 603. The UE 601 may be similar to the UE 501 in FIG. 5. The HgNB 603 may be similar to (or a component of) the home RAN 505. The UE 601 may be associated with a home network and in a service area of the home network (and a visiting network). The HgNB 603 (or associated RAN) may be configured to provide 5G data services to UEs, but not configured to provide VoNR. The HgNB 603 may transmit data to a home 5G core 605, causing a PDU session to be created for the UE 601. The home 5G core 605 may include one or more network functions, such as an IMS, AMF, SMF, PCF, etc. Thus, actions performed by the home 5G core 605 should be understood to mean that one or more network functions included in the home 5G core 605 are performing the actions. The PDU session may indicate an IMS DNN, where data (e.g., internet access) may be provided to the UE 601. The home 5G core 605 (or component thereof) may determine a QoS flow (e.g., QoS flow 1) to create the PDU session within the home network. At 604, the home 5G core 605 may complete registration of the UE 601 by creating the PDU session in a home IMS 607. The PDU session may indicate the IMS DNN, such that data may be provided to the UE 601 via the home 5G core 605.

At 606 the UE 601 may request a 5G voice call (e.g., VoIP) from the home 5G core 605. The home 5G core 605 may then update the PDU session to indicate a voice DNN. Based at least in part on the data included in the request, the home 5G core 605 may reserve resources for the voice call. For example, the AMF, SMF, PCF, etc. may operate together and/or separately according to a QoS flow (e.g., QoS flow 5) to reserve a bearer to enable the voice call, where voice data may be routed via the UPF of the home 5G core 605 to the UE 601. At 608, the PDU session in the home IMS 607 may be updated to indicate a voice DNN for the UE 601.

At 610, the HgNB 603 may transmit data rejecting the updated PDU session and indicating that the EPS fall back procedure is to be initiated to the UE 601. Similarly, at 612, the HgNB 603 may transmit data rejecting the updated PDU session and indicating that the EPS fall back procedure is to be initiated to the home 5G core 605. The home 5G core 605 may use the data to update the PDU session at the home IMS 607. For example, one or more network functions of the home 5G core 605 may determine that the voice call may not be provided to the UE via an associated RAN. The one or more network functions may then determine that the voice call may be provided using an EPS protocol administered by a roaming partner. Then, the PDU session may be updated to indicate a local node (e.g., the SMF of the home 5G core 605) and a remote node (e.g., an MME of a visiting 4G core 611).

At 614, the home 5G core 605 may also transmit data to the visiting 4G core 611 such that data handled in the PDU session may be routed through one or more network functions of the visiting 4G core 611. The visiting 4G core 611 may include an MME, an SGW, and other network functions and components to provide voice services via LTE and/or EPS. Actions performed by the visiting 4G core 611 should be understood to mean that one or more network functions included in the visiting 4G core 406119 are performing the actions. In some embodiments, the visiting 4G core 611 may also transmit data to the home 5G core 605 such that the PDU session within the home IMS 607 is updated to indicate the EPS fallback.

At 616, the UE 601 may begin the voice call using the VeNB 609 Voice data associated with the voice call may be routed through the visiting 4G core 611 to the home 5G core 605. The voice data may be at least partially routed through a user plane of both the visiting network and the home network (e.g., from the SGW of the visiting 4G core 611 to the PGW of the home 5G core 605). Thus, the voice call may continue to be home routed to the home network, although provided using a roaming network using an EPS fall back procedure.

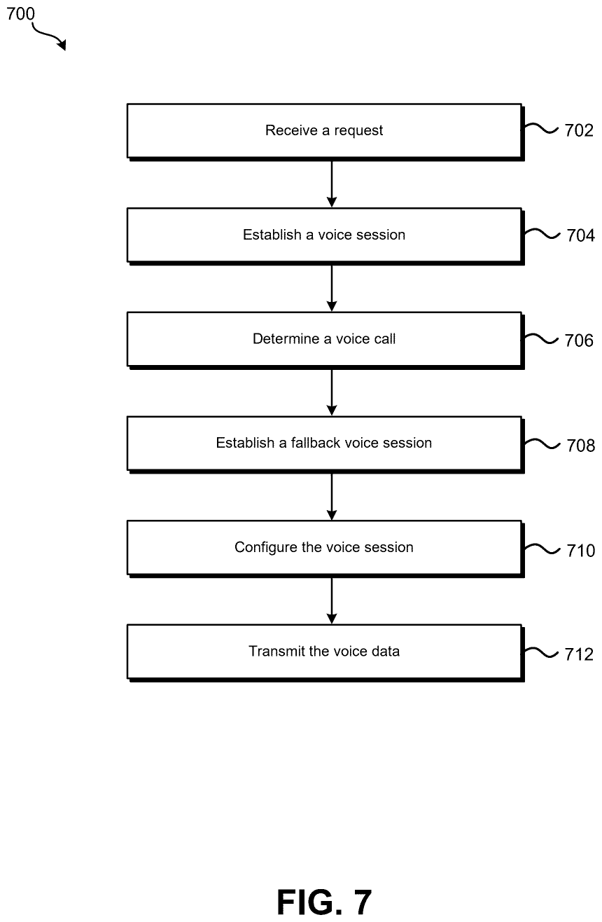

FIG. 7 illustrates a flowchart of a method 700 for providing voice services using EPS fallback, according to certain embodiments. The method 700 may be performed by some or all of the systems described herein. The steps of the method 700 may be performed in a different order than is shown and described, and/or may be combined with other steps. In some embodiments, some steps may be skipped altogether.

At step 702, the method 700 may include receiving a request for a voice call by one or more components of a 5G network, the request associated with a user equipment associated with the 5G network. The 5G network may be similar to the home network described in FIGS. 3-6. Thus the 5G network may include a 5G core with components and/or network functions such as an AMF, SMF, UPF, etc. Some or all of the 5G network may be implemented on a distributed, cloud-based architecture. The 5G network may be implemented using a open radio access network. In some embodiments, the 5G network may be a standalone 5G network, configured to provide 5G data services and 5G voice services (e.g., VoNR) to UEs.

At step 704, the method 700 may include establishing, by the one or more components of the 5G network, a voice session within the 5G network. The voice session may be a new PDU session, or may be an update to an existing PDU session. For example, an existing PDU session with a data DNN may be registered in an IMS of the 5G network. The existing PDU session may then be updated to indicate a voice DNN. In some embodiments, the one or more components of the 5G network may generate and/or reservice resources within the 5G network to provide voice services to the UE (e.g., bearer reservation, GBR reservations, etc.).

At step 706, the method 700 may include determining, by the one or more components of the 5G network, that the voice call cannot be completed by the 5G network. For example, a gNodeB of the 5G network may determine that a RAN associated with the 5G network is not configured to provide voice services using VoNR. The gNodeB may then transmit data to the UE that indicates that the request failed, and an EPS fall back is to be initiated. The one or more components of the 5G network may determine that a roaming network may provide voice service using LTE and/or EPS protocols.

At step 708, the method 700 may include transmitting, by the one or more components of the 5G network, data used to generate a fall back voice session within the roaming network. The roaming network may include a hybrid 5G/4G network. For example, the roaming network may include a 5G core for providing data services, and a 4G network for providing voice services. Then, the AMF of the 5G network may transmit a session request to an AMF and/or an MME of the roaming network. In response, the roaming network (or components thereof) may establish or update a session to be the fallback voice session (e.g., a voice DNN session) in order to provide voice services to the UE. In some embodiments, the gNodeB of the 5G network may then initiate a hand over to an eNodeB of the roaming network.

At step 710, the method 700 may include configuring, by the one or more components of the 5G network, the voice session within 5G network to allow voice data to be handled within the fall back voice session of the roaming network and in conjunction with the voice session within the roaming network, such that the voice call is home routed. In some embodiments, the request for the voice call may be received by the one or more components of the 5G network from a 5G core of the roaming network. Then, the method 700 may include registering, by the one or more components of the 5G network, the UE within the 5G network. For example, the UE may be registered in the IMS with a session indicating a data DNN. Then, the UE may be reregistered to indicate a voice DNN. In other embodiments, the UE may be registered with a new registration. The method 700 may also include receiving, by the one or more components of the 5G network, the voice data from the 4G radio access network and the 4G core of the roaming network via a user plane of the roaming network and the 5G network.

In some embodiments, the request for the 5G voice call is received from the user equipment by the one or more components of the 5G network. The method 700 may then include transmitting, by the one or more components of the 5G network, a request for a voice session to the roaming network. The method 700 may also include updating, by the one or more components of the 5G network, a registration of the user equipment to permit the voice data to be routed through 5G core of the 5G network and the 4G core of the roaming network. For example, the registration may be updated to include a local node and a remote node. The method 700 may include receiving, by the one or more components of the 5G network, the voice data from 4G core and the 4G radio access of the roaming network.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks. For example, executing instructions stored in the non-transitory computer-readable medium causes the processors to perform steps of methods and/or to implement features of components described herein.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method of home routing a voice call via a 5G network and a roaming network, comprising:
receiving, by one or more components of the 5G network, a request for a 5G voice call, the request associated with a user equipment (UE) associated with the 5G network;
establishing, by the one or more components of the 5G network, a voice session within the 5G network;
determining, by the one or more components of the 5G network, that the 5G voice call cannot be established by the 5G network and/or the roaming network;
transmitting, by the one or more components of the 5G network, data used to generate a fall back voice session with the UE and within 5G network and/or the roaming network;
configuring, by the one or more components of the 5G network, the voice session within 5G network to allow voice data to be handled within the fall back voice session of the roaming network in conjunction with the voice session within the roaming network, such that the 5G voice call is home routed; and
transmitting the voice data to the user equipment via the 5G network and the roaming network such that the 5G voice call is established.

2. The method of claim 1, wherein the 5G network is a home network of the user equipment, and the roaming network comprises a 5G core, a 4G core, and a 4G radio access network.

3. The method of claim 2, wherein the request for the 5G voice call is received by the one or more components of the 5G network from the 5G core of the roaming network, the method further comprising:
updating, by the one or more components of the 5G network, the voice session of the user equipment within the 5G network; and
receiving, by the one or more components of the roaming network and the 5G network, the voice data from the 4G radio access network and the 4G core of the roaming network via a user plane of the roaming network and the 5G network.

4. The method of claim 2, wherein the request for the 5G voice call is received from the one or more components of the 5G network, the method further comprising:
transmitting, by the one or more components of the 5G network, a request for a voice session to the roaming network;
updating, by the one or more components of the 5G network, the voice session of the user equipment to permit the voice data to be routed through 5G core of the 5G network and the 4G core of the roaming network; and
receiving, by the one or more components of the 5G network, the voice data from a 4G core and the 4G radio access of the roaming network.

5. The method of claim 1, wherein the roaming network is a hybrid 5G network.

6. The method of claim 1, wherein a session management function and a user plane function of the 5G network include an evolved packet system capability.

7. The method of claim 1, wherein the 5G network is implemented using an open radio access network.

8. The method of claim 1, wherein the 5G network is implemented on a cloud-based architecture.

9. The method of claim 1, wherein the fall back voice session utilizes an enhanced packet system.

10. A system, comprising:
one or more processors; and
a computer-readable medium comprising instructions that, when executed by the system, cause the system to perform operations to:
receive, by one or more components of a 5G network, a request for a 5G voice call, the request associated with a user equipment (UE) associated with the 5G network;
establish by the one or more components of the 5G network, a voice session within the 5G network;
determine, by the one or more components of the 5G network, that the 5G voice call cannot be established by the 5G network and/or a roaming network;
transmit, by the one or more components of the 5G network, data used to generate a fall back voice session with the UE and within 5G network and/or the roaming network;
configure, by the one or more components of the 5G network, the voice session within 5G network to allow voice data to be handled within the fall back voice session of the roaming network in conjunction with the voice session within the roaming network, such that the 5G voice call is home routed; and
transmit the voice data to the user equipment via the 5G network and the roaming network such that the 5G voice call is established.

11. The system of claim 10, wherein the 5G network is a home network of the user equipment, and the roaming network comprises a 5G core, a 4G core, and a 4G radio access network.

12. The system of claim 11, wherein the request for the 5G voice call is received by the 5G network from the 5G core of the roaming network, the operations further causing the system to:
update, by the one or more components of the 5G network, the voice session of the user equipment within the 5G network; and
receive, by the one or more components of the roaming network and the 5G network, the voice data from the 4G radio access network and the 4G core of the roaming network via a user plane of the roaming network and the 5G network.

13. The system of claim 11, wherein the request for the 5G voice call is received from the one or more components of the 5G network, the operations further causing the system to:
transmit, by the one or more components of the 5G network, a request for a voice session to the roaming network;
update, by the one or more components of the 5G network, the voice session of the user equipment to permit the voice data to be routed through 5G core of the 5G network and the 4G core of the roaming network; and
receive, by the one or more components of the 5G network, the voice data from the 4G core and the 4G radio access network of the roaming network.

14. The system of claim 10, wherein the roaming network is a hybrid 5G network.

15. The system of claim 10, wherein the 5G network is implemented using an open radio access network.

16. The system of claim 10, wherein the 5G network is implemented on a cloud-based architecture.

17. The system of claim 10, wherein the fall back voice session utilizes an enhanced packet system.

18. A non-transitory computer-readable medium comprising instructions that, when executed by one or more processors, cause the one or more processors to perform operations comprising:
receiving, by one or more components of a 5G network, a request for a 5G voice call, the request associated with a user equipment (UE) associated with the 5G network;
establishing, by the one or more components of the 5G network, a voice session within the 5G network;
determining, by the one or more components of the 5G network, that the 5G voice call cannot be established by the 5G network and/or a roaming network;
transmitting, by the one or more components of the 5G network, data used to generate a fall back voice session with the UE and within 5G network and/or the roaming network;
configuring, by the one or more components of the 5G network, the voice session within 5G network to allow voice data to be handled within the fall back voice session of the roaming network in conjunction with the voice session within the roaming network, such that the 5G voice call is home routed; and
transmitting the voice data to the user equipment via the 5G network and the roaming network such that the 5G voice call is established.

19. The non-transitory computer-readable medium of claim 18, wherein the 5G network is a home network of the user equipment, and the roaming network comprises a 5G core, a 4G core, and a 4G radio access network.

20. The non-transitory computer-readable medium of claim 19, wherein the request for the voice call is received by the 5G network from the 5G core of the roaming network, the operations further comprising:
updating, by the one or more components of the 5G network, the voice session of the user equipment within the 5G network; and
receiving, by the one or more components of the roaming network and the 5G network, the voice data from the 4G radio access network and the 4G core of the roaming network via a user plane of the roaming network and the 5G network.
